(19) United States
(12) Patent Application Publication
(10) Pub. No.: US 2020/0212840 A1
(43) Pub. Date: Jul. 2, 2020

(54) NON-THERMAL CANDOLUMINESCENCE FOR GENERATING ELECTRICITY

(71) Applicant: TECHNION RESEARCH AND DEVELOPEMENT FOUNDATION LTD., Haifa (IL)

(72) Inventor: Carmel ROTSCHILD, Ganey Tikva (IL)

(21) Appl. No.: 16/500,129

(22) PCT Filed: Mar. 29, 2018
(86) PCT No.: PCT/IL2018/050382

§ 371 Date: Oct. 2, 2019

Related U.S. Application Data
(60) Provisional application No. 62/480,459, filed on Apr. 2, 2017.

(51) Int. Cl. H02S 10/30; F23D 99/00; C09K 11/08; C09K 11/68; C09K 11/62; C09K 11/59; C09K 11/74; C09K 11/66

(52) U.S. Cl. CPC H02S 10/30; F23D 99/00; C09K 11/0822; C09K 11/661; C09K 11/62; C09K 11/59; C09K 11/7407; C09K 11/68

(57) ABSTRACT

Methods and systems convert combustion products to electricity, by efficiently coupling between photovoltaic cells with photons. The photons are emitted from a burning process of a photoluminescence material, the burning process including the chemical reaction of combustion.

### Cross-References to Related Applications

This patent application is related to and claims priority from commonly owned U.S. Provisional Patent Application Ser. No. 62/480,459, entitled: Non-thermal Candoluminescence For Generating Electricity, filed on Apr. 2, 2017, the disclosure of which is incorporated by reference in its entirety herein.

### FIELD OF THE INVENTION

The present invention is directed to a method and a system for converting combustion products to electricity.

### BACKGROUND

Candoluminescence is the light given off by certain materials at elevated temperatures, usually when exposed to a flame. The light has an intensity at some wavelengths which can be higher than the black body emission expected from incandescence at the same temperature. A “black body”, as discussed herein, is an object that absorbs all radiation falling on it, at all wavelengths. When a black body is at a uniform temperature, its emission has a characteristic frequency distribution that depends on the temperature. Its emission is called black-body radiation.

Candoluminescent devices include gas mantles. As shown in FIGS. 1A-1C, a pure Butane flame, generates poor visible radiation and high heat (FIG. 1A). This blue color arises due to excited molecular radicals. When placing photoluminescent (PL) materials at the vicinity of the flame, as is done in gas-mantles, the same burning process generates much stronger visible radiation, as shown in FIG. 1B.

FIG. 1C, shows the change in candoluminescence in the vicinity of the rare earth emitters of the gas mantle. In this example, Butane has the chemical structure of C₄H₁₂ and when burning the chemical reaction is: 2C₄H₁₀+13O₂→8CO₂+10H₂O. The heat of combustion for Butane is 2.8769[MJ mol⁻¹], which for a single molecule (dividing by Avogadro number) results in 30 eV, and for each chemical bond that is reduced the energy is about 3 eV.

This highly energetic exciton breaks the C—H bonds (425 nm emission) and C—C bons (UV/Blue/Red emission) generating free radicals. The re-bonding results the week bluish radiation in FIG. 1A. Without any additional process the energy becomes thermal, but when placing photoluminescence materials in vicinity to the reaction the exciton can be transferred to the emitter before thermalization. Extensive research on gas mantles in the 1970s optimized their luminescence in the visible light wavelength spectrum. These emissions were already recognized as non-thermal, excited by active gases or chemical radicals, as described in Henry F. Ivey, Candoluminescence and radical-excited luminescence, J. Lum., 8, 4, 271 (1974).

FIG. 2A shows conventional gas mantle containing Thorium dioxide and Cerium (ThO₂:Ce), demonstrating three orders of magnitude. FIG. 2B shows more energetic photons than Black Body radiation at the same temperature. Taking into account the sporadic emissivity of Butane in the IR region (See, http://webbook.nist.gov/cgi/cbook.cgi?ID=C106978&Units=SI&Type=IR-SPEC&Index=17#IR-SPEC), it is estimated that this visible emission is a vast portion of the total energy (above 50%). Harvesting this radiation using a wide bandgap solar cell, for example, as GaAs, E_{g}=1.35 eV or GaInP E_{g}=2.1 eV, is expected to result in total efficiency at the same order as the available radiation ˜50%. However, this does not account for other thermal losses.

### SUMMARY

The present invention, in some embodiments thereof, provides methods and systems for converting combustion products to electricity, by efficiently coupling between photovoltaic cells with photons, emitted from a burning process, such as the chemical reaction of combustion of the burning process. Embodiments of the invention are also directed to non-thermal emissions such as photoluminescence and candoluminescence where the radiance of the emission exceeds that of a thermal emission, and the emitted photons are used in generating energy.

These mechanisms of energy transfer between excitons (photons) in the present invention, are different from the energy transfer in gas mantles, which are based on heat transport for generating thermal radiation below Black Body radiation.

The present invention in some embodiments is directed to a method for converting chemical potential into electrical energy. The method comprises: providing a photoluminescence material into a chemical reaction zone associated with combustion of a fuel, to cause a chemical reaction with the combusting fuel, such that the photoluminescence material radiates photons; and, collecting the radiated photons by placing at least one photovoltaic element proximate to the chemical reaction zone associated with the combustion of the fuel, the collected photons causing the at least one photovoltaic element to generate electric current.

Optionally, the photoluminescence material is fluidized as part of a gaseous mixture.

Optionally, the photoluminescence material is in particle sizes of a diameter less than 100 microns.

Optionally, the photoluminescence material is selected from the group of: Neodymium (Nd3+), Ytterbium (Yb3+), Erbium (Er3+), Holmium (Ho3+), Praseodymium (Pr3+), Cerium Ce3+, Thorium dioxide (ThO₂), CeO, ZnO, Ytterbia (Yb₂O₃), Titanium Sapphire (Ti:Al₂O₃), Yttrium (Y³⁺), Samarium (Sm³⁺), Europium (Eu³⁺), Gadolinium (Gd³⁺), Terbium (Tb³⁺), Dysprosium (Dy³⁺), Lutetium (Lu³⁺), Bismuth Oxide (Bi₂O₃), and Transition metals of Chromium (Cr),

Optionally, the at least one photovoltaic element is selected from the group of: GaAs, GaP, Si, Ge, GeN, Si₃N₄, and PbS.

Optionally, method additionally comprises: providing a fuel flow to supply fuel for the combustion; and, providing the photoluminescence material into the chemical reaction zone includes providing the photoluminescence material into the fuel flow.

Optionally, the fuel is selected from the group of: Butane, Methane, Kerosene, gasoline, other petroleum based fuels and hydrogen.

The present invention in some embodiments is directed to a system for converting chemical potential into electrical energy. The system comprises: a chamber including an interior. The interior includes: a photovoltaic element; a burner element proximate to the photovoltaic element, the burner element for supporting fuel combustion in the form of a flame, the periphery of the flame defining a chemical reaction zone; and, a source for providing a photoluminescence material into the chemical reaction zone associated with combustion of a fuel, to cause a chemical reaction with the combusting fuel, such that the photoluminescence material radiates photons for collection by the photovoltaic element to generate electric current.

Optionally, the system additionally comprises: a fuel source in communication with the burner element.

Optionally, the source for providing the photoluminescence material is in communication with the fuel source.

Optionally, the photovoltaic element is proximate to the chemical reaction zone.

Optionally, the chamber includes at least one outlet.

Optionally, the interior of the chamber includes a filter for capturing the photoluminescence material.

Optionally, the system additionally comprises: at least one reflector in communication with the interior of the chamber.

Optionally, the at least one reflector includes a minor.

The present invention in some embodiments is also directed to a method for converting chemical potential into electrical energy. The method comprises: providing a photoluminescence material as fluidized particles in a gaseous mixture with a carrier gas into combusting fuel, such that the photoluminescence material radiates photons; and, collecting the radiated photons by placing at least one photovoltaic element proximate to the combusting fuel, the collected photons causing the at least one photovoltaic element to generate electric current.

Optionally, the method is such that the photoluminescence material is in particle sizes of a diameter less than 100 microns.

Optionally, the method is such that the photoluminescence material is selected from the group of: Neodymium (Nd3+), Ytterbium (Yb3+), Erbium (Er3+), Holmium (Ho3+), Praseodymium (Pr3+), Cerium Ce3+, Thorium dioxide (ThO₂), CeO, ZnO, Ytterbia (Yb₂O₃), Titanium Sapphire (Ti:Al₂O₃), Yttrium (Y³⁺), Samarium (Sm³⁺), Europium (Eu³⁺), Gadolinium (Gd³⁺), Terbium (Tb³⁺), Dysprosium (Dy³⁺), Lutetium (Lu³⁺), Bismuth Oxide (Bi₂O₃), and Transition metals of Chromium (Cr).

Optionally, the method is such that the at least one photovoltaic element is selected from the group of: GaAs, GaP, Si, Ge, GeN, Si₃N₄, and PbS.

Optionally, the method is such that it additionally comprises: providing a source of fuel; and, providing the photoluminescence material into the fuel flow.

Optionally, the method is such that the fuel is selected from the group of: Butane, Methane, Kerosene, gasoline, other petroleum based fuels, and hydrogen.

Optionally, in some embodiments, the photoluminescence material is in aerosol mixture with the burning components before the burning process.

Optionally, in some embodiments, the photoluminescence material is in small molecules mixed with the burning components before the burning process.

Optionally, in some embodiments, the photoluminescence material is in nano-particles at size smaller than 100 microns, mixed with the burning components before the burning process.

Optionally, in some embodiments, the photoluminescence material is in porous material as to increase surface area by more than 1000, with respect to bulk material.

Optionally, in some embodiments, the burning process is generated in the porous matrix, to allow the emitters to be at close proximity with the generated radicals.

Optionally, in some embodiments, the photoluminescence material temperature is kept above 600K.

Optionally, in some embodiments, the photoluminescence material is radiativly exited.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1A shows a butane flame;

FIGS. 1B and 1C show a gas mantle;

FIG. 2A is a diagram showing emission bands from ThO₂;

FIG. 2B shows an emission band relative to a black body;

FIG. 3A is a diagram of Emission evolution of non-thermal radiation (NTR) material with temperature;

FIG. 3B is a diagram of emission rates of energetic photons and total photons rate (inset) for

NTR and thermal emission at various temperatures;

FIG. 4A are diagrams of thermal energy photoluminescence (TEPL) dynamics;

FIG. 4B is a diagram of system efficiency as a function of the absorber and Photovoltaic (PV) bandgaps;

FIG. 5A is a diagram of an apparatus in accordance with an embodiment of the invention;

FIG. 5B is a diagram of an apparatus in accordance with an alternative embodiment of the invention;

FIG. 6A is a photograph showing thermal light associated with a flame; and,

FIG. 6B is a photograph showing non-thermal light at the edge of the flame, which is used for the flame periphery in FIGS. 5A and 5B.

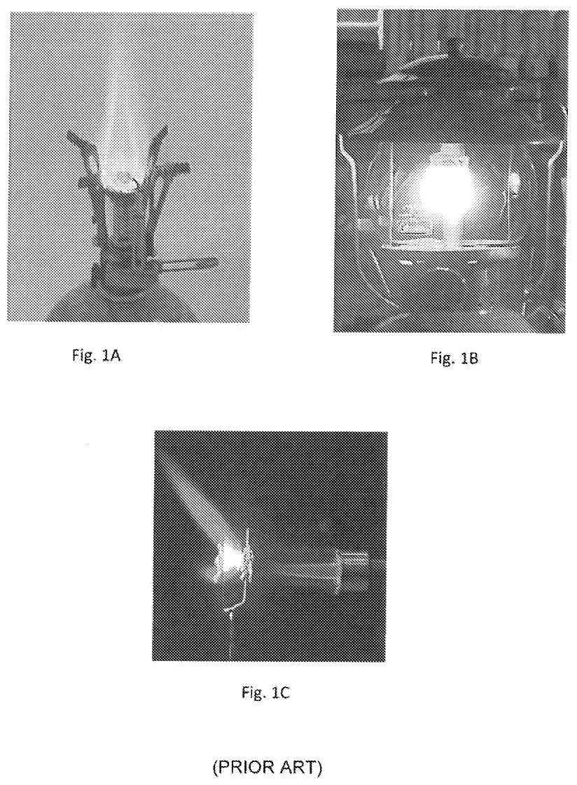

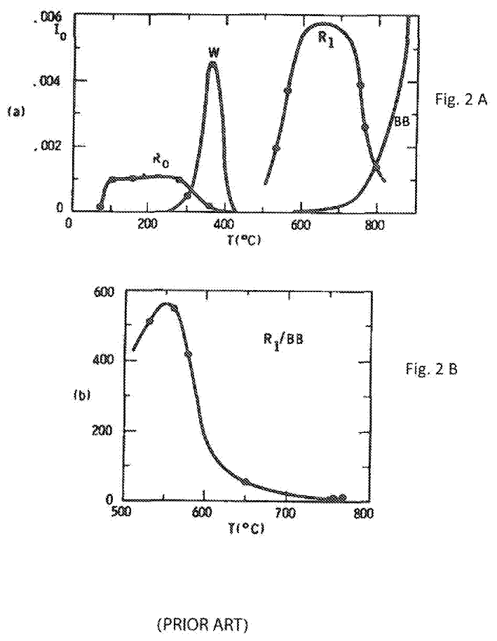

### DETAILED DESCRIPTION OF THE INVENTION

### Introduction

The inventors have discovered that, in contrast to thermal emission, the non-thermal radiation (NTR) rate is conserved with temperature increases, while each photon is blueshifted. As used herein, “blueshifted” is any decrease in wavelength, with a corresponding increase in frequency, of an electromagnetic wave. Further rises in temperature lead to an abrupt transition to thermal emission, where the photon rate increases sharply.

The fundamental physics that governs the interplay between NTR and thermal emissions is expressed by the generalized Planck's law, by Equation 1 (Eq. 1), as follows:

$$R ( ℏ ω , T , μ ) = ɛ ( ℏω ) \cdot \frac{{( ℏ ω )}^{2}}{4 {π}^{2} {ℏ}^{3} {c}^{2}} \frac{1}{{e}^{\frac{ℏω - μ}{{K}_{B} T}} - 1} ≅ {R}_{0} \cdot {e}^{\frac{μ}{{K}_{B} T}} \qquad ( Eq . 1 )$$

Where R is the emitted photon flux (photons per second per unit area). Here, T is the temperature, ε is the emissivity, ℏω is the photon energy, K_{b} is Boltzmann's constant and μ is the chemical potential. The corresponding emitted energy rate is defined by E(ℏω, T, μ)=R(ℏω, T, μ)·ℏω. The chemical potential μ>0 defines the level of excitation above the system's thermal equilibrium, R₀, and is frequency-invariant at the spectral band wherein thermalization equalizes excitation levels between modes. This is true for excited electrons in the conduction band of solid-state semiconductors as well as for excited electrons in isolated molecules, as discussed in P. Wurfel, “The chemical potential of radiation,” J. Phys. C Solid State Phys. 15, 3967 (1982).

For semiconductors, μ is the gap between the quasi-fermi-levels that is opened upon excitation. By its definition, for a fixed excitation rate, as temperature increases, μ is reduced and when μ=0 the radiation is reduced to thermal emission, R₀. Thermodynamically, the chemical potential is defined as long as the number of particles is conserved, which for NTR means constant quantum efficiency (QE), i.e., the ratio between the emitted and the quantum process rates. Equation 1 describes the excitation of electrons at a specific band where μ is constant.

Initially, any additional thermal excitation of electrons from the ground state, i.e., thermal emission, that rapidly grows with the rise of temperature, cannot be added to the NTR rate described by Equation 1. This is because such a sum of emissions would result in total thermal emission (at μ=0) that exceeds the Black Body radiation. In another intuitive description; the expectation that a low radiance thermal source (heating below critical temperature) increases high radiance NTR is similar to the expectation that a cold body heats a hot body. This violates the 2^{nd} law of thermodynamics.

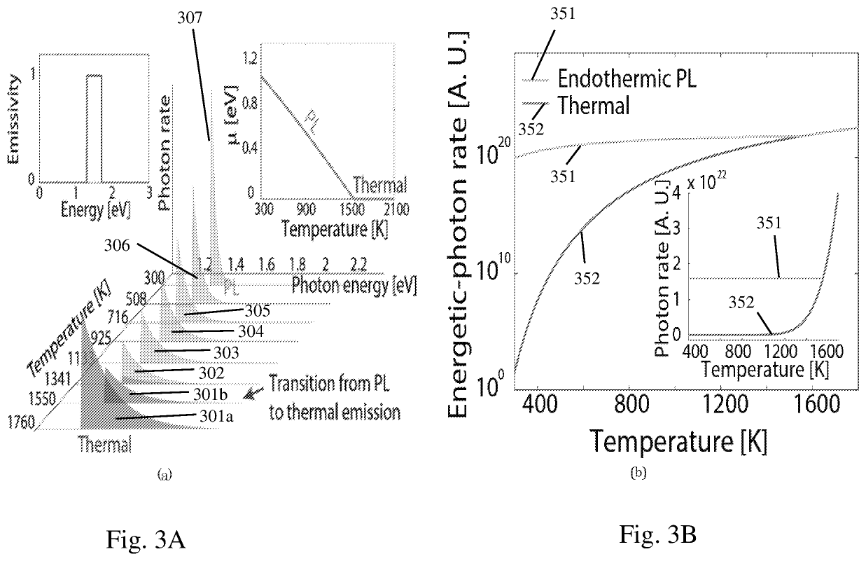

With this in mind, the NTR evolution of an ideal material is simulated, under constant quantum process rate and temperature increase. For the sake of generality the material is chosen to have a band-like emissivity function, as shown in FIG. 3A. This emissivity function can describe both materials with discrete energy gaps, such as small molecules, and semiconductors (by expending the emissivity into the high energy spectrum). As an example, the emissivity function is chosen to be unity between 1.3 eV and 1.7 eV and zero elsewhere. In addition, at this stage, the NTR is assumed to have unity quantum efficiency (QE) and only radiative heat transfer is accounted for. Eq. 1 is solved by balancing the incoming and outgoing photonic and energy rates, at steady state. For a given incoming quantum process rate and energy-rate, the solution uniquely defines the thermodynamic state of the NTR absorber, which is characterized by its quantities T and μ. The only way to conserve both the NTR and energy rates is if each emitted photon is blue-shifted with the increase in pumped heat.

FIG. 3A presents the evolution of emission spectrum and chemical potential (inset) as function of temperature. FIG. 3B presents the total emitted photon rate (inset) and the rate of photons with energy above 1.45 eV in the case of endothermic NTR (line 351) and thermal emission (line 352). The thermal emission is calculated by setting μ=0, and applying only the energy balance. As evident, at low temperatures, the emission's line shape at the band-edge is narrow, and is blue-shifted with temperature increase (FIG. 3A), while the total emitted photon rate is conserved (FIG. 3B inset). In contrast to thermal emission, this process is characterized by the reduction of photon rate near the band edge, where electrons are being thermally-pumped to the high energy regime as long as μ>0.

The portions 301a, 301b and 302-307 of the emission in FIG. 3A represents the thermal population, R₀. At low temperatures (302-307) the NTR photon rate is far above the rate of thermal emission, while R₀ increases and becomes significant at high temperatures (301a, 301b). The temperature rise leads to the reduction in the chemical potential, according to the relation:

$$μ ( T ) = {K}_{B} T \cdot ln ( \frac{\int R \cdot d ( ℏ ω )}{\int {R}_{0} \cdot d ( ℏω )} ) \qquad ( Eq . 2 )$$

This trend continues until μ=0 , where the emission becomes purely thermal. For the computation in this case, the constraint for balance between the absorbed and NTR photon rates is removed. Further rise in temperature results in a sharp increase of the photon rate at all wavelengths. Examining the generation rate of photons with energy above 1.45 eV, corresponding to λ<850 nm (FIG. 3B) shows the emitted rate of energetic photons in the endothermic NTR case (line 351) is orders of magnitude greater than in thermal emission under the same temperatures (line 352). At μ=0, both energetic photon rates converge.

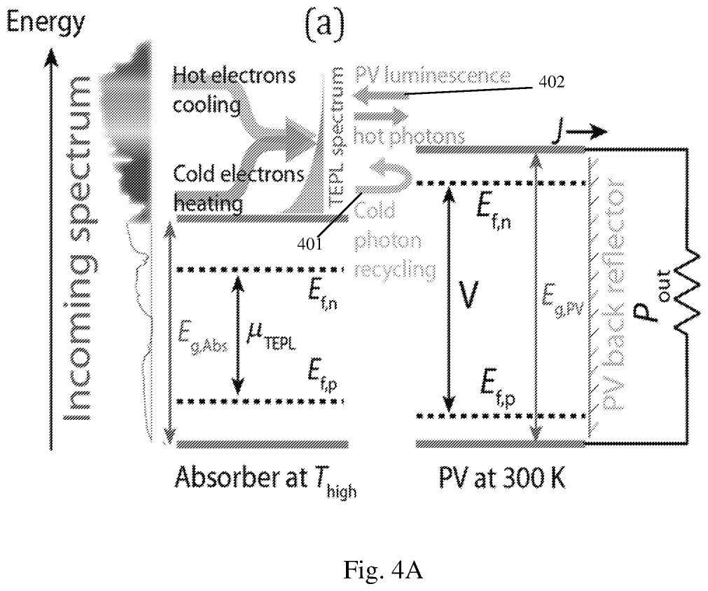

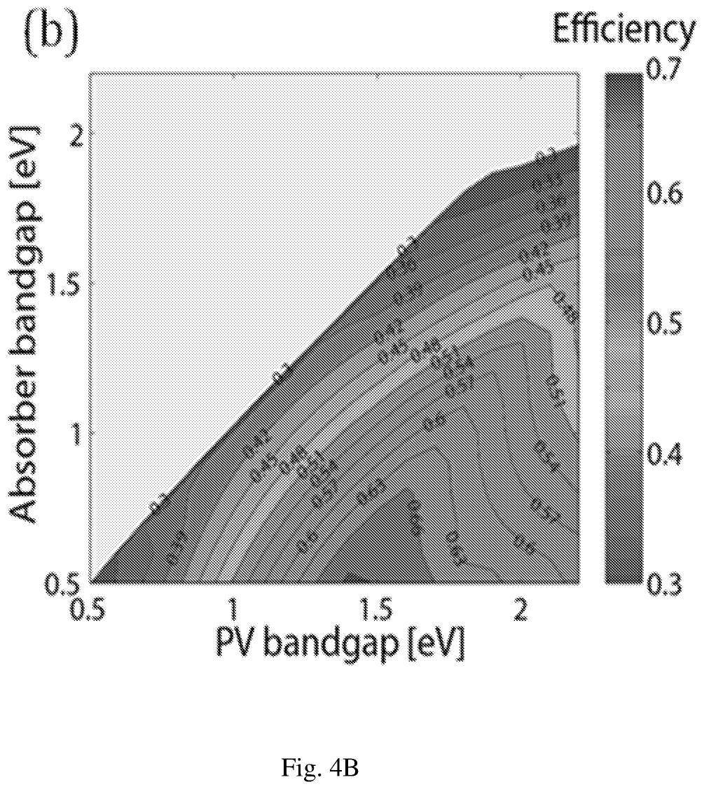

Attention is now directed to FIGS. 4A and 4B. FIG. 4A shows conversion dynamics Here, the solar spectrum above E_{g,Abs} is absorbed by the luminescent absorber and emitted as Thermally enhanced photoluminescence (PL) towards the photovoltaic (PV) material. Sub-bandgap photons are recycled back to the absorber (arrow 401) while above E_{g,PV} photons are converted to current. For an ideal photovoltaic, its photoluminescence is also recycled to the absorber (arrow 402). FIG. 4B shows the efficiency of the system as a function of the absorber and photovoltaic bandgaps.

The inventors initially established general guidelines for a fuel cell device where the NTR candoluminescence replaced the photoluminescence (PL), and the chemical reaction generates non-thermal excitation in similar way to the solar radiation absorbed in the PL absorber. For the thermodynamic analysis, we consider a theoretical Thermally enhanced photoluminescence (TEPL) device including a thermally insulated, low bandgap TEPL absorber that completely absorbs the solar spectrum above its bandgap (E_{g,Abs}), as depicted in FIG. 4A. Energetic photon absorption increases the absorber's temperature by electron thermalization, and induces thermal upconversion of cold electron-hole pairs, as indicated by the arrows. The resulting emission spectrum is TEPL, which, according to Eq. (1), is described by T_{high} and μ_{TEPL}>0. While the thermally upconverted portion of the TEPL above the E_{g,PV} bandgap is harvested by a room-temperature PV, sub-bandgap photons are reflected back to the absorber by the PV cell back reflector, as in state-of-the-art GaAs cells (arrow 401 in FIG. 4A), maintaining the high TEPL chemical potential. The emitted PV luminescence, which in the radiative limit has an external quantum efficiency (EQE) of unity, is also recycled back to the absorber (arrow 402). Thus, the otherwise dissipated thermalization energy of the absorber is converted to increased voltage and efficiency at the PV. The ability to generate both high current (due to the absorber low bandgap) and high voltage paves the way to exceeding the SQ limit, inherently set by the single-junction PV current-voltage tradeoff.

The device thermodynamic simulation is achieved by detailed balance of photon fluxes, based on Equation 1. The calculation accounts for the different systems variables, such as the two bandgaps, the solar concentration ratio upon the absorber, the absorber's EQE, the sub-band photons recycling efficiency (PR) and the PL EQE of the PV. The simulation yields the device's I-V curve at various operating temperatures, from which the system's efficiency can be deduced.

The simulation results of the maximal theoretical efficiency for each absorber and PV bandgap combination, when all the parameters are set to their ideal values are depicted in FIG. 4B. For each E_{g,Abs}, the efficiency initially increases with the increase in E_{g,PV}, but decreases for higher values due to the tradeoff between voltage gain at the PV and loss of photons due to the reduction in the harvested portion of the spectrum. This tradeoff sets a maximal efficiency of 70% for E_{g,Abs}=0.5 eV and E_{g,PV}=1.4 eV, at a temperature of 1140 K.

Using similar physical concepts to generate electricity from the chemical potential and heat generated in a flame process (temperature of 1200C-1900C), a high efficiency fuel-cell, in accordance with the present invention, is built. In this high efficiency fuel cell, the chemical reaction in a flame conserves the chemical potential as a non-thermal radiation (μ>0), which is then converted into electricity.

### Apparatus

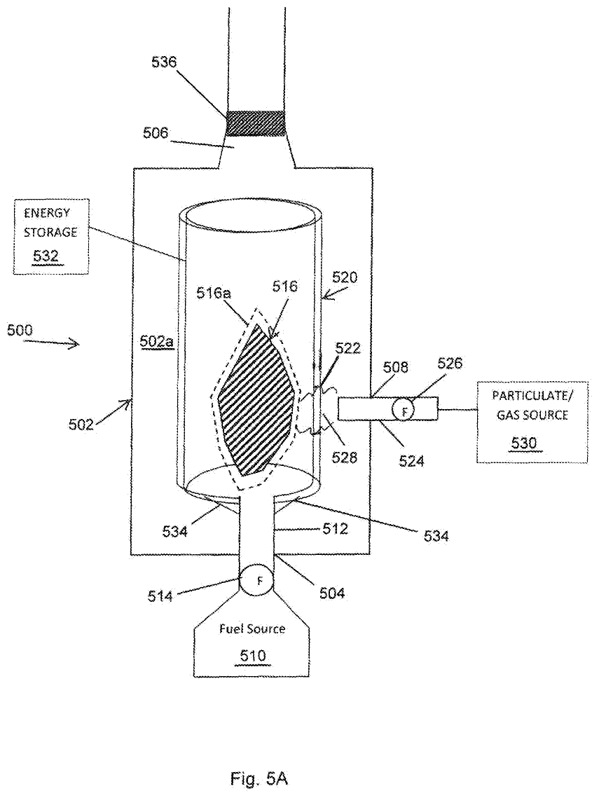

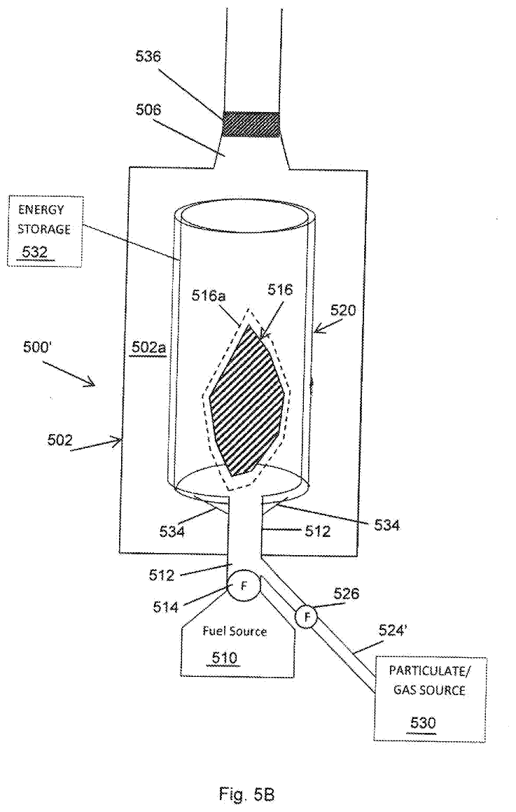

FIG. 5A shows an apparatus 500, operating, for example, as a fuel cell. The apparatus 500 includes a housing 502, which in its interior is a chamber 502a. The housing 502 includes an inlet 504 for fuel and oxygen, and one or more outlets 506 (one shown) for exhaust gases. There is also an inlet 508, through which photoluminescent materials, for example, as particulates, immersed in carrier gases, such as oxygen, in a gas mixture, enter the housing 502.

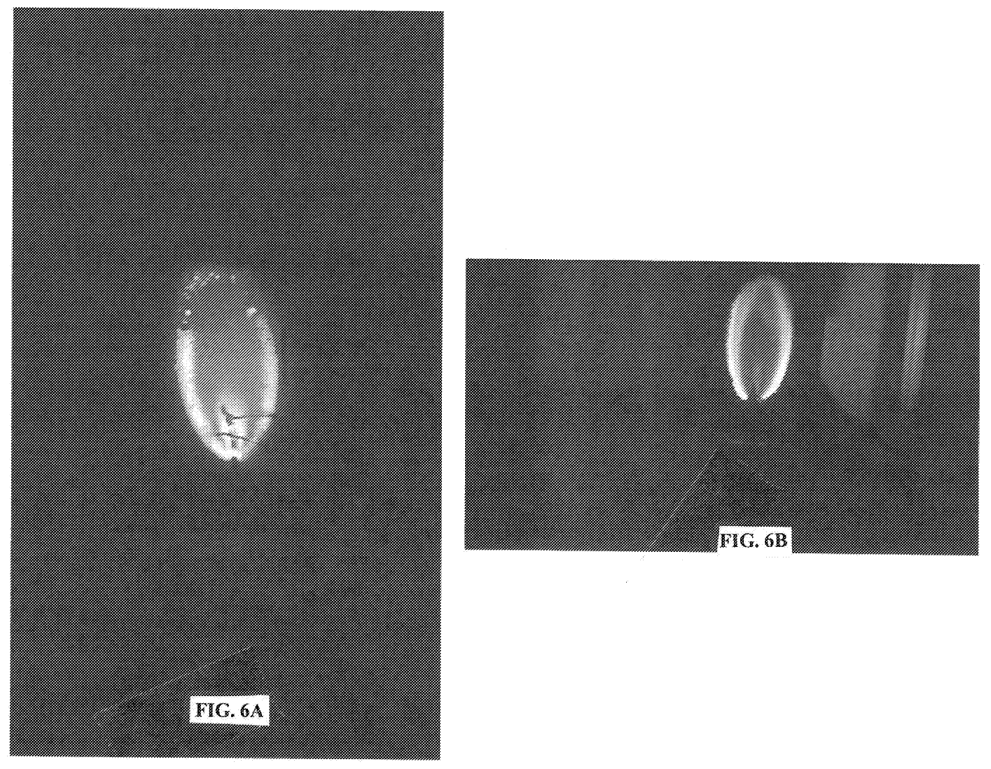

A fuel source 510, in communication with a conduit 512 extending through the inlet 504, provides fuel and gas, e.g., oxygen, as provided by a feed mechanism (F) 514 to support a flame 516, at the end of the conduit 512 (the conduit 512 being part of a burner (burner element)). The flame periphery is shown by the broken line area 516a. At this periphery 516a, chemical reactions associated with combustion (a chemical reaction which involves the rapid combination of a fuel with oxygen causing the production of heat and light) are occurring, and as a result, the flame periphery 516a can also be a chemical reaction zone. The flame periphery 516a utilized non-thermal radiation from the flame 516, light, as shown in FIG. 6B (when compared to the thermal radiation from the light of FIG. 6A). The fuel of the fuel source 510 includes, for example, gasoline, Butane, Methane, Kerosene, other petroleum-based fuels, hydrogen, and the like.

A photovoltaic element 520 is within the chamber 502a, and at least partially envelopes the flame 516. The photovoltaic element 520 is positioned proximate to the flame 516, in order to capture the photons, also known as excitons, emitted (radiated) from photoluminescent material, resulting from the burning of the flame 516, and combustion associated therewith. The photovoltaic element 520 includes an opening 522, through which a conduit 524 (and a feed mechanism (F) 526 therein) supplies a gaseous mixture 528 of photoluminescent particles and gas, e.g., oxygen, from a source 530, to the flame 516. For example, the gaseous mixture 528 is fed so as to contact the periphery 516a of the flame 516. Additionally, for example, the gaseous mixture 528 is fed to the periphery 516a of the flame 516, to chemically react with the combustion in the chemical reaction zone. The photoluminescent particles at the vicinity (e.g., periphery 516a) of the flame 516 transfer the photons (excitons), released on contact with the burning flame 516.

By using the fluidized photoluminescent particulates in a gaseous mixture, there is close proximity between the emitter (the photoluminescent particles) and the generated radical. The emitter can be re-flow through the gas for recycling. Alternately, another form of mixing that allows efficient excitonic energy transfer by maintaining close proximity is an aerosol mixture, which is a colloid of fine solid nano-particles or liquid droplets, in gas environment. Yet another alternative involves mixing small molecule-emitters with the gas.

The photoluminescence particles (emitters) are in proximity to the free radicals or other molecules caused by the burning flame 516, and are excited by energy transfer from the free radicals or other molecules to the photoluminescence particles (emitters). As the chamber 502a, typically including a membrane (not shown) surrounds the flame 516 in order to block the photoluminescence particles (emitters) from escaping while letting the CO₂ exit, through the outlet 506. The photoluminescence particles (emitters) sink into the bottom of the chamber 502a where they are recycled and re-fed into the flame 516.

The photoluminescent particles mixed with the gas in the source 530 include, for example, Neodymium (Nd3+), Ytterbium (Yb3+), Erbium (Er3+), Holmium (Ho3+), Praseodymium (Pr3+), Cerium Ce3+, Thorium dioxide (ThO₂), CeO, ZnO, Ytterbia (Yb₂O₃), Titanium Sapphire (Ti:Al₂O₃), Bismuth Oxide (Bi₂O₃),Yttrium (Y³⁺), Samarium (Sm³⁺), Europium (Eu³⁺), Gadolinium (Gd³⁺), Terbium (Tb³⁺), Dysprosium (Dy³⁺), and Lutetium (Lu³⁺). and Transition metals Chromium (Cr). The photoluminescent particles are, for example, of a diameter of 100 micrometers or less, so as to be fluidized and flow with the carrier gas. The carrier gas is, for example, oxygen (O₂).

The photovoltaic element 520 is also in communication with an energy storage unit 532, as the photons collected by the photovoltaic element 520 are used for generating electric current and are stored in the energy storage unit 132. The photovoltaic element 520 is made of materials including, for example, GaAs, GaP, Si, Ge, GeN, Si₃N₄, PbS, and the like. The photovoltaic element 520 is also known as a photovoltaic cell.

Optionally, within the chamber 502a are reflectors, for example, mirrors 534. These mirrors 534 function to reflect generated photons toward the photovoltaic element 520 for capture by the photovoltaic element 520.

A filter 536 is placed in the outlet 506 for capturing the photoluminescent particles, as they enter the outlet 506 in the exhaust gases.

FIG. 5B, an alternate embodiment apparatus 500′ is similar to the apparatus 500, with similar and/or identical components having the same element numbers, as are in accordance with their descriptions in FIG. 5A. The apparatus 500′ differs from the apparatus 500, in that the gaseous mixture of photoluminescent particles and gas, from the gas source 530, is delivered by a conduit 524′ into the conduit 512, for delivery with the fuel and/or combustion gases.

In order to optimize electricity generation, some example parameters of optimization include: heat of combustion, energy transfer of the photoluminescent emitter, QE of the photoluminescent emitter, and matching between emission wavelength and available photovoltaic bandgap.

Alternative embodiments of the apparatus 500, 500′ may include one or more features, such as:
matching the material of the photovoltaic elements to the radiation emitted from the photoluminescent materials of the burning process;
the photoluminescence material temperature is kept above 600K;
the photoluminescence material is radiativly exited;
placing photoluminescence materials at the vicinity of the chemical reaction (the burning process chemical reaction zone);
providing structure for increasing the burning temperature;
providing structure for reflecting stray radiation to reach the photovoltaic element;
providing structure for reflecting radiation of sub bandgap photons back to the burning material;
providing structure for controlling the incoming and exiting gas of the burning process;
providing structure for maintaining efficient energy transfer between the initial excitons on the interacting molecules in the burning process and the photoluminescence emitter. Such high efficiency is essential for external emission above thermal radiation and high conversion efficiency to electricity at the photovoltaic element;
providing structure for exciton to transfer from one molecule to another by a mechanism such as Forster Energy Transfer (FRET) and Dexter energy transfer. In these mechanisms high efficiency energy transfer requires close proximity between the donor molecule and acceptor in the order of 1 nm-10 nm. Therefore, a structure that maintains the close proximity has high surface area and allows efficient flow (small drag) for the ingredient and products of the burning process gases. Such a structure can be made of pols, fibers or thread where the acceptor molecule is spread on the surface at concentration that minimizes quenching of the photoluminescence (maintaining high quantum efficiency). The space between these pols, fibers or thread allows the efficient flow of gases. However due to the boundary layer which inherently reduces gas-flow at the vicinity of a solid body, any solid structure may support limited interaction between the flow of radicals and the PL material in the solid.

Alternative embodiments of the apparatus 500, 500′ include structure for an energy transfer mechanism, that is radiative where the radiation emitted by the burning molecules is absorbed and induces photoluminescence that is coupled to the photovoltaic element. This allows maintaining of the burning process at high temperature behind a transparent window, while the photovoltaic element absorbs the radiation and remains thermally insulated from the burning process. This increases the efficiency of the photovoltaics, as temperature is known to damage photovoltaics efficiency.

Alternative embodiments of the apparatus 500, 500′ include structure for controlled gas flow on high surface area of a porous matrix, that maintains the photoluminescence emitters proximate to the burning process (e.g., flame 516). Such a three-dimensional (3D) structure accounts for the oxygen and gas concentration distribution at steady burning. For this, the porous size of the photoluminescent particles is such that surface area increases by more than a factor of 1000 with respect to bulk media. The density of the photoluminescence emitters in the porous media is sufficiently high to maintain the distance between emitter molecules less than the Froster Energy Transfer (FRET) distance, which is typically about 5 nm apart. For Dexter energy transfer, 1 nm proximity is required. This result in emitter concentration of between 0.1%-10% in weight depending on the molecular weight.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

What is claimed is:

1. A method for converting chemical potential into electrical energy, comprising:
providing a photoluminescence material into a chemical reaction zone associated with combustion of a fuel, to cause a chemical reaction with the combusting fuel, such that the photoluminescence material radiates photons; and,
collecting the radiated photons by placing at least one photovoltaic element proximate to the chemical reaction zone associated with the combustion of the fuel, the collected photons causing the at least one photovoltaic element to generate electric current.

2. The method of claim 1, wherein the photoluminescence material is fluidized as part of a gaseous mixture.

3. The method of claim 2, wherein the photoluminescence material is in particle sizes of a diameter less than 100 microns.

4. The method of claim 3, wherein the photoluminescence material is selected from the group of: Neodymium (Nd3+), Ytterbium (Yb3+), Erbium (Er3+), Holmium (Ho3+), Praseodymium (Pr3+), Cerium Ce3+, Thorium dioxide (ThO₂), CeO, ZnO, Ytterbia (Yb₂O₃), Titanium Sapphire (Ti:Al₂O₃), Yttrium (Y³⁺), Samarium (Sm³⁺), Europium (Eu³⁺), Gadolinium (Gd³⁺), Terbium (Tb³⁺), Dysprosium (Dy³⁺), Lutetium (Lu³⁺), Bismuth Oxide (Bi₂O₃), and Transition metals of Chromium (Cr).

5. The method of claim 1, wherein the at least one photovoltaic element is selected from the group of: GaAs, GaP, Si, Ge, GeN, Si₃N₄, and PbS.

6. The method of claim 1, additionally comprising:
providing a fuel flow to supply fuel for the combustion; and,
providing the photoluminescence material into the chemical reaction zone includes providing the photoluminescence material into the fuel flow.

7. The method of claim 6, wherein the fuel is selected from the group of: Butane, Methane, Kerosene, gasoline, other petroleum based fuels, and hydrogen.

8. A system for converting chemical potential into electrical energy, comprising:
a chamber including an interior including:
a photovoltaic element;
a burner element proximate to the photovoltaic element, the burner element for supporting fuel combustion in the form of a flame, the periphery of the flame defining a chemical reaction zone; and,
a source for providing a photoluminescence material into the chemical reaction zone associated with combustion of a fuel, to cause a chemical reaction with the combusting fuel, such that the photoluminescence material radiates photons for collection by the photovoltaic element to generate electric current.

9. The system of claim 8, additionally comprising: a fuel source in communication with the burner element.

10. The system of claim 9, wherein the source for providing the photoluminescence material is in communication with the fuel source.

11. The system of claim 10, wherein the photovoltaic element is proximate to the chemical reaction zone.

12. The system of claim 11, wherein the chamber includes at least one outlet.

13. The system of claim 12, wherein the interior of the chamber includes a filter for capturing the photoluminescence material.

14. The system of claim 8, additionally comprising at least one reflector in communication with the interior of the chamber.

15. The system of claim 14, wherein the at least one reflector includes a minor.

16. A method for converting chemical potential into electrical energy, comprising:
providing a photoluminescence material as fluidized particles in a gaseous mixture with a carrier gas into combusting fuel, such that the photoluminescence material radiates photons; and,
collecting the radiated photons by placing at least one photovoltaic element proximate to the combusting fuel, the collected photons causing the at least one photovoltaic element to generate electric current.

17. The method of claim 16, wherein the photoluminescence material is in particle sizes of a diameter less than 100 microns.

18. The method of claim 17, wherein the photoluminescence material is selected from the group of: Neodymium (Nd3+), Ytterbium (Yb3+), Erbium (Er3+), Holmium (Ho3+), Praseodymium (Pr3+), Cerium Ce3+, Thorium dioxide (ThO₂), CeO, ZnO, Ytterbia (Yb₂O₃), Titanium Sapphire (Ti:Al₂O₃), Yttrium (Y³⁺), Samarium (Sm³⁺), Europium (Eu³⁺), Gadolinium (Gd³⁺), Terbium (Tb³⁺), Dysprosium (Dy³⁺), Lutetium (Lu³⁺), Bismuth Oxide (Bi₂O₃), and Transition metals of Chromium (Cr).

19. The method of claim 16, wherein the at least one photovoltaic element is selected from the group of: GaAs, GaP, Si, Ge, GeN, Si₃N₄, and PbS.

20. The method of claim 16, additionally comprising:
providing a source of fuel; and,
providing the photoluminescence material into the fuel flow.

21. The method of claim 20, wherein the fuel is selected from the group of: Butane, Methane, Kerosene, gasoline, other petroleum based fuels, and hydrogen.
